(19) United States
(12) Patent Application Publication
(10) Pub. No.: US 2009/0290554 A1
(43) Pub. Date: Nov. 26, 2009

(54) SYSTEM, METHOD AND COMPUTER ACCESSIBLE MEDIUM FOR DETERMINING ACTION TIME IN A COMMUNICATION NETWORK

(75) Inventors: Sami Siltala, Kempele (FI); Roman Pichna, Espoo (FI); Sandro Grech, Helsinki (FI)

Correspondence Address: DORSEY & WHITNEY LLP;INTELLECTUAL PROPERTY DEPARTMENT, 250 PARK AVENUE, NEW YORK, NY, 10177, US

(73) Assignee: Nokia Siemens Networks Oy, Espoo (FI)

(21) Appl. No.: 12/120,123

(22) Filed: May 13, 2008

(51) Int. Cl. H04W 36/00

(52) U.S. Cl. 370/331

(57) ABSTRACT

Exemplary embodiments of system, method and computer accessible medium are provided for determining an action time in a communication network is described. For example, it is possible to estimate, in a target network arrangement, a value for an action time, with the value for the action time corresponding to the value for a handover time interval related to the target network node. The handover time interval can be a time interval starting substantially at the time when a first signal is received by a serving network node, which includes information about the value for the action time. For example, the handover time interval can have a duration during which the target network node is prepared to receive a handing over user equipment and the first signal. Further, the first signal can include information about the value for the action time, and such signal may be transmitted from a target network node to a serving network node.

### FIELD OF THE INVENTION

The present invention relates to communication networks. In particular, the present invention relates to system, method and computer-accessible medium for (i) determining an action time in a communication network, and/or (ii) distributing an action time value, to a target network node, to a serving network node and a telecommunication system.

### BACKGROUND INFORMATION

In a wireless network, a terminal or a mobile unit moves in a certain region. The distance for radio signals, which signals may link a base station and a mobile unit, can be limited since the air attenuate a signal propagating through the air. Thus, in a wireless network, a cell structure can be formed around the so-called base stations. In order to cover a region a plurality of cells is installed such that the footprint of the cells may cover the corresponding area.

However, at the border of the cells, when a mobile terminal crosses that border, a situation may exist that the mobile station may have to be handed over from one base station to another base station.

When connecting to a target base station during a handover (HO) procedure, a mobile station (MS) may have to proceed through a ranging process. The ranging process may be a contention-based process. The contention, in particular the time which is consumed for changing the base station, may add latency and may retard the operability of the MS.

This latency may be avoided by allocating dedicated fast ranging opportunities to the MS. This fast handover procedure is supported by IEEE 802.16e-2005 standard for Local and Amendment 2: Physical and Medium Access Control Layers for Combined Fixed and Mobile Operation in Licensed Bands, February 2006.

Furthermore, the fast handover procedure is described in a WiMAX Forum document, WiMAX Forum Network Architecture, Stage 2 and 3, Rel. 1, Ver. 1.2, January 2008.

For conducting the fast ranging opportunities, an action time value may be transmitted to the serving base station from every candidate of base station for receiving a mobile terminal. The action time received by the serving base station however, may vary.

There may be a need to provide a more effective handover procedure for a mobile terminal (e.g., a WiMAX mobile terminal).

### SUMMARY OF EXEMPLARY EMBODIMENTS OF THE INVENTION

According to an exemplary embodiment of the present invention, system, method and computer-accessible medium can be provided for (i) determining an action time in a communication network, and/or (ii) distributing an action time value, a target network node, a serving network node and a telecommunication system.

According to a particular exemplary embodiment of the present invention system, method and computer-accessible medium for determining an action time in a communication network may be provided. In this exemplary embodiment, it is possible to estimate, in a target network node, a value for an action time such that the value for the action time corresponds to the value for a handover time interval related to the target network node. For example, during the handover time interval, the target network node can be prepared or configured to receive a handing-over of the user equipment.

In one exemplary embodiment, handing-over a user equipment or an MS may mean that the serving network node release an association with the MS and a target network node associates with an MS. Associating with an MS may mean that the target network node may receive an MS. e.g., the target network node may store a context for the MS.

In another exemplary embodiment, a handover time interval can be a time interval starting substantially at the time when a first signal is received by a serving network node. The first signal can comprise information about the value of the action time. The handover time interval has a duration during which duration the target network node may be prepared for a handover of a user equipment.

For example, during the duration of the handover interval, the target network node may be ready or configured for conducting a fast handover of the user equipment, e.g., the target network node may be ready to receive a handing over user equipment with providing a fast ranging opportunity.

In another exemplary embodiment of the system, method and computer-accessible medium, the first signal (which may comprises information about the value of the action time) may be transmitted from a target network node to a serving network node. For example, the value of the action time may be pre-compensated. Further, the serving network node can receive the first signal comprising information about the value of the action time.

In still another exemplary embodiment of the present invention, a second signal can be transmitted to the user equipment. Such second signal can comprise information about the value of the action time. It is possible that some compensation for the action time have been conducted before the second signal (comprising information about the second action time) can be transmitted to the user equipment. For example, the second signal may comprise an action time value. According to one exemplary embodiment, the action time value can represent or be associated with a latency for a transmission between the serving network node and the target network node and a processing latency of the serving network node may have been compensated.

Indeed, according to a further exemplary embodiment of the present invention, an action time in a communication network can be determined. For example, in a target network node, a value for an action time can be estimated such that the value for the action time, as signalled to the user equipment after processing in the serving network node, may correspond to the same value for a handover time interval for a plurality of target network nodes. During the handover time interval, the target network node can be prepared or configured to receive a handing-over MS. The plurality of target network nodes may be a group of target network nodes, which target network nodes may be potential candidates for receiving a user equipment.

The serving network node or the source base station may compensate a received action time value for latency by regarding the latency estimate. Thus, if each of a plurality of target network nodes may transmit a pre-compensated value for a corresponding action time and the action time of each of the plurality of the target network nodes may have the same value, the serving network node may achieve by compensating latency in the serving network node that the resulting action time value for all of the plurality of target network nodes may substantially be the same in the serving network node. Thus, a single value for an action time may be reported to user equipment.

According to one exemplary embodiment, in order to provide that most or all of the plurality of target network nodes may have the same value, the serving network node may communicate the selected value to the user equipment and to the plurality of target network nodes. The plurality of target network nodes may adopt their action time value to this chosen action time value.

Thus, an exemplary predefined processing of the action time in the serving network node according to an exemplary embodiment of the system, method and computer-accessible medium of the present invention may comprise further compensating the action time value for the estimate of the latency, which latency may be a latency from the target network node to the serving network node, and a processing time latency within the serving network node. This exemplary action time value may have been pre-compensated by the target network node.

For example, if the serving network node may receive a plurality of action time values, the serving network node may select at least one value of the plurality of values. In particular, if the serving network node may receive a plurality of different action time values, the serving network node can select one value of the plurality of different values. The serving network node may compensate the action time value before the serving network node may chose a value of the compensated action times from the plurality of values of action time. The selected value of the action time may be communicated to the user equipment (mobile station). This compensation may be performed, e.g., by subtracting the latency estimates from the value of the action time.

According to another exemplary embodiment of the present invention, system, method and computer-accessible medium may be provide for distributing an action time value is provided. For example, it is possible to receive a plurality of action time values in a serving network node, and select one or more values of the plurality of action time values. The selected action time value(s) can be distributed to a user equipment and to at least one target network node. Providing at least one target network node of the plurality of target network nodes with the same value of an action time may facilitate an alignment of the target network nodes.

According to another exemplary embodiment of the present invention, a target network node may be provided, which can include an estimating device and a transmitting device. The estimating device can be adapted or configured to estimate a value for an action time such that the value for the action time corresponds to the value for a handover time interval related to the target network node. The handover time interval may be a time interval starting substantially at the time when a first signal, which can include information about the value for the action time, may be received by a serving network node. The handover time interval furthermore can have a duration during which duration the target network node is prepared for handing-over user equipment.

For example, the target network node may be ready for receiving a user equipment by providing a fast ranging opportunity. Thus, a contention while handing over the user equipment may be avoided. The transmitting device can be adapted to transmit the first signal to a serving network node, which signal comprises information about the value of the action time from the target network node.

In one exemplary embodiment, the action time may relate to the time interval, during which time interval the target network node is in an operational mode for enabling a fast handover of a user equipment. The action time may be related to a frame of reference of the serving network node. In other words, the action time of the target network node may be converted to a time reference in the serving network node. Therefore, the serving network node may receive information about a time interval during which time interval the serving network node may hand of the MS to a selected target network node and during which time interval the target network node may allow a fast handover. Consequently, the serving network node may avoid complicate calculations for determining the handover time interval, during which the target base station may allow fast handover seen from the perspective of the serving network node.

According to another exemplary embodiment of the present invention, a serving network node can be provided. For example, the serving network node may include a receiving device, a selecting device and a transmitting device. The receiving device can be adapted or configured to receive at least one first signal comprising information about a value for an action time from at least one corresponding target network node.

The selecting device can be adapted or configured to select one of one or more values for an action time, whereas the first signal can include information about the value of the action time. The selecting device may compensate each of a plurality of action time values received from a plurality of target network nodes. Thus, for each received action time value, the serving network node may subtract a latency estimation for transporting information between a target network node and a serving network node and/or a processing time latency. The processing time latency may be a value representing the duration for processing an action time within the serving network node. The compensation in the serving network node may be independent from the pre-compensation in the target network node. The transmitting device can be adapted or configured to transmit the selected signal comprising information about a value for an action time to a user equipment.

According to yet another exemplary embodiment of the present invention, a telecommunication system can be provided. The telecommunication system may include at least one target network node and at least one serving network node. Such serving network node(s) may be adapted or configured to handover a user equipment to the at least one target network node.

According to a further exemplary embodiment of the present invention, system, method and computer accessible medium can be provided for transmitting an action. For example, in a target network node, a value for an action time may be estimated such that the value for the action time corresponds to the value for a handover time interval in the target network. The handover time interval may be a time interval starting substantially at the time when a first signal is received by a serving network node, and the first signal can include information about the value for the action time. The handover time interval may furthermore have a duration during which duration the target network node is prepared for a handover of a user equipment. The first signal, which can include information about the value for the action time, may be transmitted from the target network node to a serving network node.

According to yet further exemplary embodiment of the present invention, system, method and computer accessible medium can be provided for receiving an action time. For example, in a serving network node, a first signal may be received which can include information about a value for an action time. Further, a second signal (transmitted to a user equipment) may include information about a value for the action time. According to another exemplary embodiment of the present invention, a computer accessible medium may be provided, which can include program code. For example, when the program code is executed by a processor, the processor can be configured to carry out the procedure for (i) determining an action time, (ii) distributing an action time value, and/or (iii) sending and/or receiving an action time.

A computer-readable medium may be, for example, a CD-ROM (Compact Disk Read Only Medium), a RAM (Random Access Memory), an EPROM (Erasable Programmable Read Only Memory), a DVD (Digital Versatile Disk) or an USB stick (Universal Serial Bus).

For example, an action time may indicate an instance, when a target base station (T-BS) or target network node may give a dedicated fast ranging opportunity to a mobile station (MS) in a fast handover (HO) process. In other words, an action time may be a value, which value may be defined as a number of frames or slots until the target BS (base station) may allocate a dedicated transmission opportunity for an RNG-REQ (Range Request) message to be transmitted by the MS using fast ranging. Thus, by using a RNG-REQ message an MS may signal to a T-BS that the MS may want to move to the T-BS using a fast handover procedure.

In particular, a serving base station complying with the IEEE 802.16 e standard may not send more than one action time for a fast handover to a user equipment, a mobile terminal, a mobile station or an MS. However, a serving base station or a serving network node may receive different values of action times from different target base stations. If a serving base station may receive a plurality of action times, the serving base station may have to choose one of the plurality of action times for transmitting the selected action time to the MS.

An MS may be associated with at least one base station. For example, the MS may have established a communication relationship between the particular base station. The MS may regularly conduct measurements of a signal strength, in order to determine which base station may provide good conditions for the MS. The MS may decide which base station the MS prefers to connect to. If the MS may decide to connect to another base station, e.g., because the conditions of connection to the actual base station may degrade, the MS may signal to the serving base station (S-BS) or to the serving network node that the MS may intend to connect to another base station. The base station, which the MS may intend to connect to may be called a target base station (T-BS). It is possible to include a plurality of target base stations, which may all be candidates for receiving the MS.

In order to accelerate the handover from the serving base station to the target base station, the corresponding target base station may facilitate a fast handover. A fast handover may mean that the target base station provide for a certain time interval a context for the relevant MS, which provision of context may prevent a time consuming ranging procedure. For example, the resources for the MS may be allocated in the target base station. The handover may be triggered by the MS or the serving BS. The serving BS may be the base station, to which base station the MS is connected before a handover respectively a handoff may take place. The target base station may be one of a plurality of candidates which may be prepared to receive an MS after a handover.

During a WiMAX fast handover, the target base station may reserve a dedicated fast ranging opportunity for the MS in order to allow a substantially contention-free ranging procedure. The action time may define the number of frames until all recommended BSs may allocate a dedicated transmission opportunity for a RNG-REQ (Range Request Message) message of the MS. An identifier, e.g., a HO_ID, may be assigned to the MS, and the identifier may identify the MS during the initial ranging.

According to still another exemplary embodiment of the present invention, it is possible to determine an action time such that the action time may substantially take into account a travelling time, a delay, a propagation time or a round trip delay for a signal, and such signal may be used for informing a serving base station about the action time of a target base station. For example, the target base station may send action times with the same values in order to prevent that the values received in the serving base station from the target base station candidates differ from each other.

According to still another exemplary embodiment of the present invention, it is possible to distribute a value for an action time to a user equipment and to a plurality of target network nodes in order to align the action time for that user equipment in the plurality of target network nodes. Thus, if the serving base station may receive substantially the same values, the serving base station may substantially not have to choose between a plurality of values of different action times. An exemplary criterion for selecting one of a plurality of different values for the action time may be to select the smallest value.

Thus, the probability for successfully conducting a fast handover may be increased and a slow contention-based CDMA (Code Division Multiple Access) ranging procedure may be prevented. In other words, a base station complying with the IEEE 802.16 e standard may not be able to send more than one action time for a fast handover to an MS. However, a serving base station may receive a plurality of different values of action times from different target base stations. The serving base station may choose one value which value the serving base station may transmit to the MS. This exemplary value may indicate the duration of a time interval, within which time interval the MS may be allowed to conduct a fast handover to the target base station.

The serving base station may receive the action times with the same value from a plurality of potential target base stations. For example, the same value for all action times may be reached by compensating the signal delay over the R4 and the R6 interface and the potential latencies caused within network elements for relaying or processing the information. Thus, e.g., according to one exemplary embodiment, only one action time may be sent from the serving base station to the MS and this action time may be valid for all of the plurality of candidates for a target base station.

The latency between the serving BS and the target BS may be evaluated in order to pre-compensate these latencies. Latency may be introduced via the R6 and the R4 interface, wherein the R6 interface may be used to connect a base station, in particular a serving base station and a target base station to an ASN-GW (Access Service Network-Gateway). The R4 interface may be used to connect at least two ASN-GWs one with another.

The pre-compensation of the latencies may reduce a spread of different action time values, which values may be received within the S-BS. Substantially only one value for the action time may be provided to the serving base station, which value may be valid for all the candidates of target base stations. This value, which may be received by the serving base station, may be signalled to the MS via the R1 interface. Such exemplary value may also be signalled to the target base station via the R6 and/or the R4 interface, whereas the target base station may adopt or configured this value for the action time. Thus, future action time calculations may be conducted using the actual value for an action time common to the target base station candidates.

Thus, according to yet another exemplary embodiment of the present invention, it is possible to use the T-BS to S-BS latency in order to estimate a value which value may be used to pre-compensate the action time values. The exemplary action time values may be set by a target BS. The T-BS to S-BS latency may be the delay for a signal travelling between a T-BS and an S-BS. Pre-compensating the action time value in the T-BS may cancel a contrary compensation of the action time value in the S-BS.

The pre-compensation of the action time values may reduce the spread of action time values, which action time values may be received by the S-BS. In other words, within a corresponding target base station the information about latency for exchanging messages with a corresponding S-BS may be used in order to amend a nominal action time value such, that at the serving base station the latency for sending information from the target base station to the serving base station may be taken into account. Thus, the exemplary action time values of different target base stations may be normalized. This normalization may make the action time values from different target base stations comparable.

For example, the S-BS may receive action time values from all T-BS, and these T-BS may be candidates to handover the MS from the S-BS or which T-BS may be candidates to receive the MS from the S-BS. The S-BS may decide on one value, since the S-BS may substantially receive only one value from all potential target BS. Only one value may also mean a plurality of different values, wherein the spread between the values may be small. In other words, the action time values may overlap over a large range or over a large interval.

Such substantially one value may be signalled from the serving BS to the MS. For signalling the value for the action time from the S-BS to the MS, an MOB_BSHO-RSP message may be used, which message is defined in the R1 specification. The MOB_BSHO-RSP message may be a mobile BSHO (Base Station Handover) response message. The substantially one value may also be transmitted from the serving base station to the target base station using an HO_ACK (Handover Acknowledge) message, which HO_ACK message may be defined in the R4/R6 standard. The HO_ACK message may follow the receipt of an HO_RSP (Handover Response) message, which message may also be defined in the R4/R6 standard. The T-BS may adopt the new value as action time for the MS, i.e. the T-BS may take over the new value as action time for the corresponding MS.

Provided herein, the system, method and computer-accessible medium for determining an action time is be described. These exemplary embodiments may also apply for the target network node, the serving network node, the method for distributing an action time, the method for sending an action time, the telecommunication system, the method for receiving an action time, the program element for determining an action time, the program element for distributing an action time, the program element for sending an action time and the program element for receiving an action time.

According to another exemplary embodiment of the present invention, the system, method and computer-accessible medium can be used to estimate, in a further target network node, a value for a further action time such that the value for a the further action time corresponds to the value for further handover time interval related to the further target network node. The handover interval may be the time interval starting substantially at the time when a further first signal may be received by a serving network node, and the further first signal can include information about the value for the action time.

The further handover time interval may have a duration, during which duration the further target network node may be prepared for a handover of a user equipment, in particular the target network node may be prepared for a fast handover of a user equipment. For example, the target network node may be prepared to receive a handing over user equipment. It is also possible to transmit a further first signal comprising information about a value for the further action time from the further target network node to the serving network node. Furthermore, in the serving network node, the further first signal can be received which may include information regarding the value for the further action time. In the serving network node, e.g., one value of the values for the action time and the value for the further action time may be selected. Substantially, the value for the action time and the value for the further action time may be equal, since a pre-compensation may be conducted by the target network node and/or by the further target network node.

A second signal, which can include information about the selected value for the action time may be transmitted to the user equipment. The second signal may additionally be transmitted to the target network node. The additional transmission to the target network node, e.g., to the plurality of target network nodes, may be conducted in parallel with the transmission to the user equipment.

Thus, according to one exemplary embodiment, a plurality of target network nodes may be available, which target network nodes may be candidates for a handover of the user equipment from the serving network node. Pre-compensating the action time may facilitate within the serving network node preventing a selection of a plurality of values. In cases, where different values for action times may be provided, the serving base station may have to choose one of a plurality of values for an action time. An exemplary selection criteria may be to choose the largest value for the received action times or to base the selection on a HO readiness value of a corresponding user equipment.

According to another exemplary embodiment of the present invention, the estimation in the target network node of the value for an action time can include a determination in the target network node of a value for a delay of at least one message transmitted from the serving network node to the target network node. Knowing the delay, the time delay, the round trip delay, the travelling time or propagation time may facilitate a target network node to estimate the time which may be consumed to transmit a message from the target network node to a serving network node and in the opposite direction. The delay may comprise physical transmitting delays, calculation times within network equipments and time which may be consumed within network elements for storing and forwarding the information.

The estimation for the delay for a message in the direction from the target base station to the serving base station may be based on transmitting the signal from the serving base station to the target base station. Thus, a message which may be exchanged between the serving base station and the target base station can be used to determine the delay.

According to another exemplary embodiment of the present invention, the estimation in the target network node of the value for an action time can include a determination in the serving network node of at least one value for a delay of at least one message transmitted from the target network node to the serving network node. Furthermore, the estimation of the value for an action time further can include the transmission of one or more values for the delay from the serving network node to the corresponding target network node. The determination of the delay in the serving network node may facilitate the use of a message transmitted from the target network node to the serving network node in order to determine a delay time.

According to another exemplary embodiment of the present invention, it is possible to determine, in the corresponding target network node, a statistic value for a plurality of values for the delay. The delay may be determined after each message may be arrived in the target network node. However, the target network node or the serving network node may also prepare a list, matrix or a table storing a plurality of values. Thus, a statistical evaluation may be made using the values, in order to determine a substantially accurate value for the delay. Thus, the accuracy for determining a value for the action time may be increased.

According to another exemplary embodiment of the present invention, the determination in the serving network node of a statistic value for a plurality of values for the delay can be performed.

According to yet another exemplary embodiment of the present invention, the estimation in a target network node of a value for an action time can include the subtraction of a value for a delay for transmitting a message from a nominal value of an action time. By subtracting a value for a delay the action time value may be normalized. Thus, action time values, which may be prepared in a similar way of normalizing, may be comparable within a serving base station. The normalization may allow that a serving network node receives from a plurality of different target network nodes values for an action time, which are substantially equal. The different target base stations may be located in different locations. Therefore, each target base station may have to calculate a corresponding action time starting with the nominal action time. The nominal action time may be replaced by an action time distributed by the serving base station.

According to still another exemplary embodiment of the present invention, the determination of an action time can include the determination of a value for the duration of transmitting at least one message selected from the group of messages, the group of messages consisting of a HO_RSP message, a HO_ACK message and a HO_REQ (Handover Request) message. The messages may be transmitted between T-BS and S-BS. HO_RSP, HO_ACK and HO_REQ may be messages defined by the R4/R6 interface, which interfaces may connect a plurality of ASN-GW and a plurality of base stations. Using such standardized messages may facilitate a reduction of an effort for introducing a method for determining an action time.

Such exemplary messages may be configured such that information regarding the time and/or a time stamp may be transported. For example, a vendor specific parameter provided within the corresponding message may be used to transport the time stamp information.

Further exemplary embodiments according to the present invention can be provided for distributing an action time. These exemplary embodiments may also apply for the target network node, the serving network node, the method for determining an action time, the method for sending an action time, the telecommunication system, the method for receiving an action time, the program element for determining an action time, the program element for determining an action time, the program element for sending an action time and the program element for receiving an action time. According to a further exemplary embodiment of the present invention, the value for the action time can be distributed to the user equipment and the target network node in parallel. According to still another exemplary embodiment of the present invention, at least one of the user equipment, the target network node and the serving network node is a WiMAX apparatus or a WiMAX network node. A WiMAX network node is a network node which complies with the IEEE 802.16 standard.

For example, the use of the terms target network node and serving network node herein does not restrict the functionality of the network nodes. The terms may be seen as names for the network nodes in order to differentiate between the network nodes. A single network node may be a target network node and a serving network node depending on the direction of the MS.

It has also to be noted that exemplary embodiments of the present invention and exemplary embodiments of the invention have been described with reference to different subject-matters. In particular, some exemplary embodiments have been described with reference to apparatus type claims whereas other exemplary embodiments have been described with reference to method type claims. However, a person skilled in the art will gather from the above and the following description that unless other notified in addition to any combination features belonging to one type of subject-matter also any combination between features relating to different subject-matters in particular between features of the apparatus or system claims, method claims and computer-accessible medium claims should be considered to be disclosed with this application.

These and other exemplary embodiments of the present invention will become apparent from and elucidated with reference to the embodiments described hereinafter. Exemplary embodiments of the present invention will be described in the following with reference to the following drawings.

### BRIEF DESCRIPTION OF THE DRAWINGS

Further objects, features and advantages of the present invention will become apparent from the following detailed description taken in conjunction with the accompanying figures showing illustrative embodiments of the present invention, in which:

FIG. 1 is a block diagram of a target network node according to an exemplary embodiment of the present invention;

FIG. 2 is a block diagram of a serving network node according to an exemplary embodiment of the present invention;

FIG. 3 is a block diagram of a telecommunication system according to an exemplary embodiment of the present invention;

FIG. 4 is a message flow diagram for pre-compensating an action time at a target base station according to an exemplary embodiment of the present invention; and

FIG. 5 is a message flow diagram for collecting latency values according to an exemplary embodiment of the present invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF EXEMPLARY EMBODIMENTS

FIG. 1 shows a block diagram of a target base station 100 according to an exemplary embodiment of the present invention. For example, the target base station 100 can include an estimating device 101 and a transmitting device 102. Furthermore, the target network node 100 may comprise an R6 interface 103 which can facilitate the target base station 100 to connect to an ASN-GW, which is not shown in FIG. 1.

The estimating device 101 can be used in order to determine an action time for a serving base station. In particular, the estimating device 101 can determine the value of an action time such that a delay is considered, which may be introduced since the target base station 100 and a serving network node or serving base station are not located at the same physical location.

The estimating device 101 in the target network node 100 may extract a delay value from a message received from the serving base station. The serving base station is not shown in FIG. 1. The estimating device 101 has stored a nominal action time, and the estimating device calculates an action time such that a latency value can be subtracted from the nominal action time value.

The estimation device 101 may adopt the nominal value if the target network node 100 receives a value for an action time distributed by a serving network node.

The nominal action time can be a predefined value which specifies the duration for being in an operating mode, in which operating mode the target network node can conduct a fast handover. For example, if the target network node is in a mode in which a fast handover may be conducted, the target network node can be prepared or configured to receive a user equipment for associating the user equipment with the target base station 100.

For example, the target network node 100 can have stored context for a particular mobile station during the period of time, the target network node 100 facilitates a fast handover of the mobile station. After determining an action time, the action time is transmitted from the transmitting device 102 via the interface 103 to the serving base station. The estimating device 101 and the transmitting device 102 are connected by the physical connection 104.

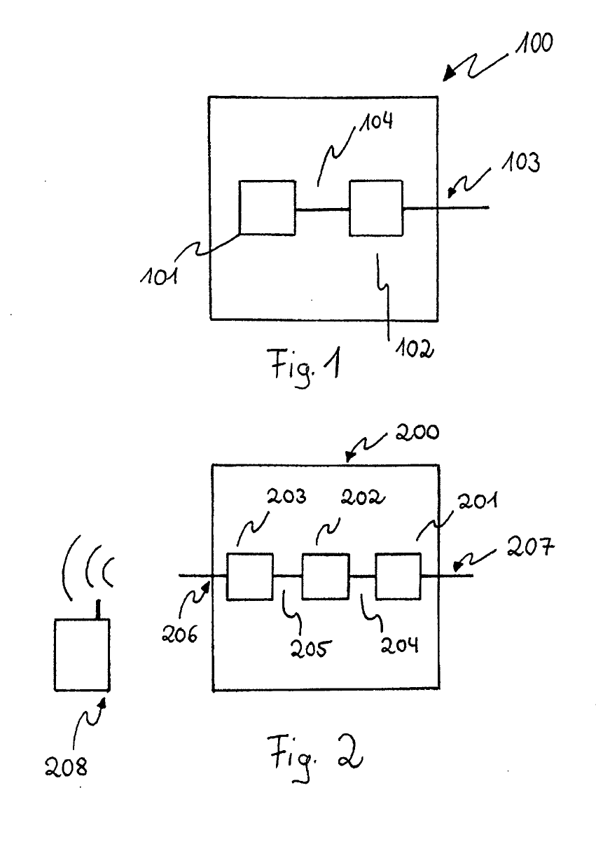

An exemplary embodiment of the serving network node 200 according to the present invention, which is depicted in FIG. 2, can include the receiving device 201, the selecting device 202 and the transmitting device 203. The selecting device 202 is connected to the receiving device 201 via connection 204 and to the transmitting device via the connection 205. The transmitting device has a radio interface 206, for example an R1 interface. For example, the serving network node 200 can connect to an MS 208 via the radio interface 206. The serving network node may administrate an association of the S-BS 200 with the MS 208. The serving network node 200 may distribute a value for an action time to a plurality of target network nodes and to a user equipment. The serving network node 200 may be adapted or configured to perform the procedure of distributing an action time value to a plurality of target network nodes.

For example, the receiving device 201 may include a receiving interface 207, e.g., an R6 interface. The serving network node 200 receives, via the receiving device 201, an action time and in particular a pre-compensated action time provided by a corresponding target network node or by a target base station, which is not shown in FIG. 2. If a spread of different action time values is received by the receiving device 201 the selecting device selects one of the plurality of received action time values. If equal values for action time are received via the receiving device 201 the selecting device 202 may not have to select one of the values. Then, the selecting device 202 takes, e.g., the single received value and transmits this only one value or the selected value via the transmitting device 203 and the transmitting interface 206 to the MS 208.

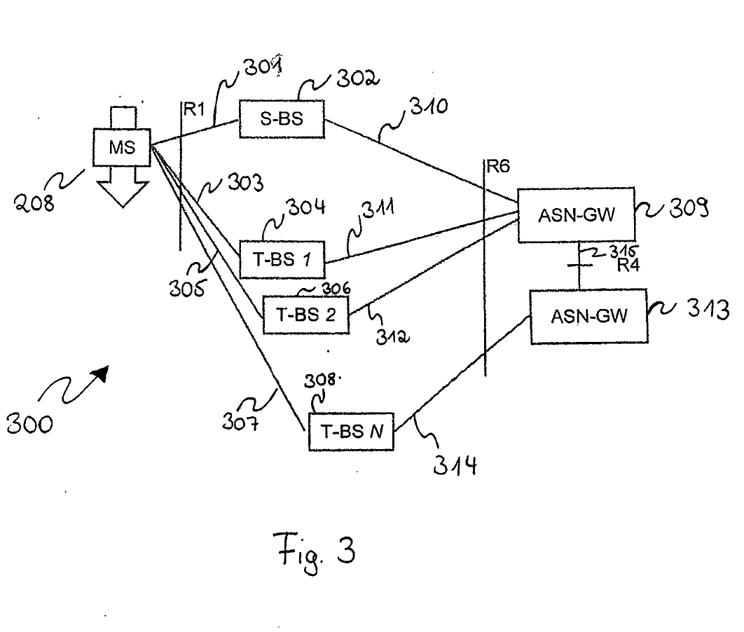

FIG. 3 shows a telecommunication system according to an exemplary embodiment of the present invention. The telecommunication system 300 or the telecommunication network 300 shown in FIG. 3 may is based on a WiMAX access network architecture. For example, the mobile station 208 can be associated via the R1 interface 301 of the serving base station 302. The MS 208 additionally has a connection via the first R1 interface 303 to the first target base station 304, via the second R1 interface 305 to the second T-BS 306 and via the third R1 interface 307 to the n-th T-BS 308.

The target base stations 304, 306, 308 of the exemplary telecommunication system 300 are potential candidates for a handover of the MS 208 from the serving base station 302. The serving base station 302 is connected to the first ASN-GW 309 via the R6 interface 310. The first target base station 304 is connected to the first ASN-GW via the first R6 interface 311. The second base station 306 is connected to the first ASN-GW 309 via the second R6 interface 312. The n-th target base station 308 is connected to the second ASN-GW 213 via the nth R6 interface 314. The first ASN-GW 309 and the second ASN-GW 213 are connected via the R4 interface 315. A connection between a base station 302, 304, 306, 308 and an ASN-GW 309, 313 may be a tunnel or a microwave link.

The target base stations 304, 306, 308 may have different distances to the serving base station 302. Thus, a propagation time for a signal from the target base station 304, 306, 308 to the serving base station 302 may be different. Further, additional latency to a signal transported from one of the target base stations 304, 306, 308 to the serving base station 302 may be introduced by a calculating time and a processing time within the ASN-GWs 309, 313. Thus, a nominal value for an action time which may be equal for the three base stations 304, 306, 308 and which may be transmitted to the serving base station 302 may generate different effective action times, caused by the propagation delay for a signal from a target base station 304, 306, 308 to the serving base station 302.

A pre-compensation of the propagation delay may be conducted within the target base station 304, 306, 308 before the action time is transmitted to the serving base station 302. For example, the action time, which is the duration during which duration the target base station 304, 306, 308 can be prepared to conduct a fast handover for MS 208, may be generated such, that the action times for the different target base stations 304, 306, 308 are equal in the moment, when a signal comprising the information about the action time arrives in the serving base station 302. Within S-BS 302, the action times of different target nodes 304, 306, 308 may be aligned.

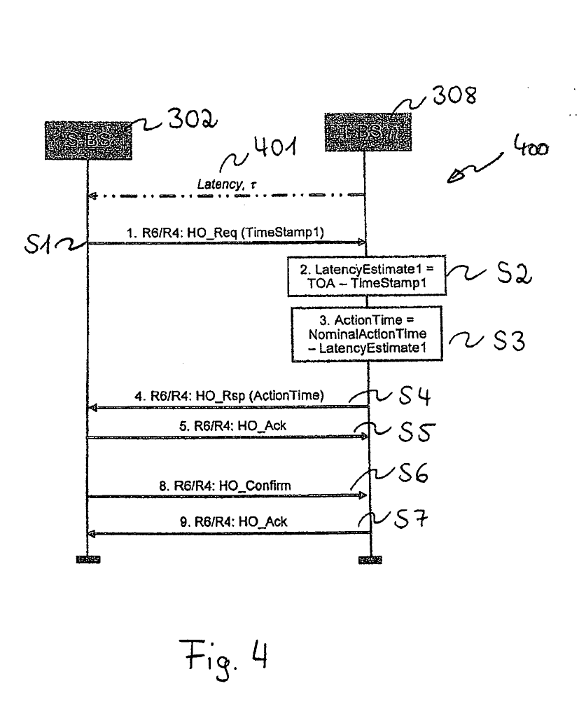

FIG. 4 shows the message flow diagram 400 for a communication relation between the serving base station 302 and the n-th target base station 308 according to an exemplary embodiment of the present invention. A comparable communication relation exists between serving base station 302 and first target base station 304 and serving base station 302 and second target base station 306. Since a physical distance exists between the serving base station 302 and the target base station 308, any signal exchanged between the base stations 302, 308 may have a latency 401, τ.

For example, in a first step S1 shown in FIG. 4, the serving base station 302 sends an HO_REQ message via the R6/R4/R6 interface 310, 315, 314 to the target base station 308. The serving base station 302 sets in the HO_REQ message a value corresponding to the actual time when the serving base station 302 sent the HO_REQ message. This time value may be used as a time stamp determining a start time of a transmission from the S-BS 302 to the T-BS 308.

In step S2, the target base station 308 can determine an estimation of latency 401 by subtracting the time stamp value included in the HO_REQ of step S1 from a time of arrival (TOA) value determined within the T-BS 308. The time stamp value and the time of arrival value are generated by a synchronized time reference, e.g., GPS (Global Positioning System)-synchronized clock within the serving base station 302 and the target base station 308. The GPS-synchronized clock may allow that within the serving base station 302 and the target base station 308 substantially the identical time is available.

In step S3 a value for an action time, for an adapted action time, can be determined within the target base station 308 by subtracting the value for the estimation of latency, calculated in step S2, from a nominal action time value. The nominal action time value may be a value stored within the target base station 308 and may be a predefined value defining how long the target base station may provide a context for a fast handover for the MS. The exemplary determined action time value in step S4 may be transmitted to the serving base station 302 inside a HO_RSP message. The S-BS 302 can respond to the HO_RSP with a HO_ACK via the R4/R6 interface 310, 314 in step S5.

In step S6, the serving base station 302 transmits an HO_Confirm (Handover confirm) message to the target base station 308 and in step S7, the target base station 308 sends an HO_ACK via the R6/R4 interface 310, 314 to the S-BS 302. The T-BS 308 or target base station 308 can estimate the latency for a delay for a transport of a message or a signal 401 between the S-BS 302 and the T-BS 308. The T-BS 308 may make a single estimation using a single latency value. Alternatively, the target base station 308 can generate a statistic for the latency values by collecting for a predefined time a number of latency values and calculating an average value for the latency value. The statistic may provide a more exact estimation since the statistic takes into account values collected over a period of time. For example, the period of time lies within a predefined time window.

Using the single latency estimation value or the collection of latency estimation values, the target base station 308 decides on the action time. In other words, the target base station 308 can determine the action time. For example, the latency estimation can be based on an estimation made by the target base station 308 for the opposite direction of a signal propagation from the serving base station 302 to the target base station 308. This estimation of step S1 can be obtained by time stamping an HO_REQ message at the S-BS 302 before sending the HO_REQ messages to the target base station 308. The time stamp value may then be subtracted from the time of arrival (TOA) of the HO_REQ message at the target base station 308.

Alternatively the latency can be estimated within the target base station 308, e.g., by estimating the latency for messages sent from the S-BS 302 to the T-BS 308 on the history or on the collected statistics of a plurality of latency values. For the statistics, the T-BS 308 can collect a short-term statistics of latency estimates for all HO_REQ samples or HO_REQ messages which the T-BS 308 has received from the S-BS 302 during a configurable time window.

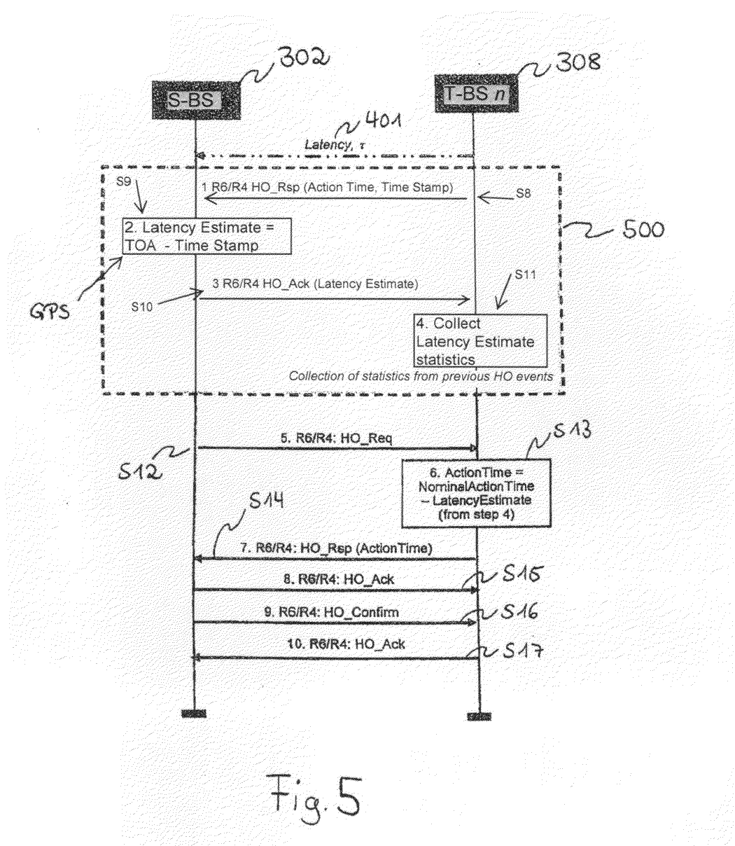

FIG. 5 shows a message flow diagram for a method for collecting latency estimates in a T-BS 308 in accordance with an exemplary embodiment of the present invention. For example, within block 500, a history of statistical information can be collected before an action time is calculated. Thus, block 500 shows collecting statistics from previous HO events. The details of the block 500 is provided below in further detail.

For example, in step S8, a HO_RSP (Handover Respond) message can be transmitted from the T-BS 308 to the S-BS 302 via the R6/R4 interface 310, 314. The HO_RSP message comprises a value for the action time, whereas the value may be determined by the T-BS 308. The messages distributed in block 500 may have been generated by handover procedures of other terminals. Such messages can be signals from the history of handovers of other MSs from this particular S-BS 302 to that particular T-BS 308. For example, there have been many other terminals handing over before the handover event triggered in step S12. The signalling used in the history is used for latency estimates. The direction for the signals may be irrelevant for determining a latency. Similarly, the statistics for latency or a single value for latency may be collected in the S-BS. Thus, the S-BS may also distribute statistical information to the T-BS.

Furthermore, the HO_RSP message may include a time stamp value, which can indicate the time when the HO_RSP message of step S8 was sent from the T-BS 308 in the direction to the S-BS 302. The received time stamp information may be taken by the S-BS 302 in step S9 to determine a latency estimation by subtracting the time stamp value from the time of arrival (TOA) of the HO_Resp message in the S-BS 302. The latency estimate can be a value which may correspond to the latency τ 401. The determined latency estimation in step S10 may be transmitted from the S-BS 302 to the T-BS 308 using a HO_ACK (Handover Acknowledge) message.

The latency estimation values, which have been calculated by the S-BS 302, can be collected in step S11 by T-BS 308. The collection of an estimated latency value may be used within T-BS 308 to generate statistics. Deploying statistics may be more accurate than using single latency estimation. Thus, a collection of statistics from previous handover events is stored in the T-BS 308.

For example, in step S12, a HO_REQ can be transmitted from the S-BS 302 to the T-BS 308. In step S13, the T-BS 308 may determine an action time by subtracting the latency estimation value from the collection of values collected in step S11 from the nominal action time stored within the T-BS 308. In particular, a statistical value may be generated from the collection of collected values. For example, an average value for all collected values is calculated. The statistical value can be subtracted from the nominal action time in order to calculate the actual action time. Thus, the latency can be pre-compensated within T-BS 308.

In step S14, a HO_RSP (which can include a value of the actual action time calculated in step S13) may be transmitted from T-BS 308 to S-BS 302. The HO_RSP message from step S14 can be confirmed in step S15 with a HO_ACK message. In step S16, a HO_confirm message may be transmitted from S-BS 302 to T-BS 308. In step S17, T-BS 308 can send a HO_ACK message to S-BS 302.

Thus, the S-BS 302 can estimate the latency and reports the latency to the T-BS 308. The T-BS 308 can collect the latency statistics, e.g., the T-BS 308 may prepare a list including latency values. The T-BS 308 time stamps a HO_RSP signal in step S8. In other words, the T-BS 308 writes a value corresponding to the actual time taken by the T-BS 308 into a corresponding field of a HO_RSP message.

The S-BS 302 may subtract the time stamp value from the actual time (TOA) in order to get a sample of latency. The S-BS 302 (in step S10) can return the sample of the latency within a HO_ACK message to the T-BS 308. The T-BS 308 (in step S11) may collect short-term statistics. The short-term statistics can be collected within a configurable time window. The T-BS 308 may use the collected short-term statistics to calculate the current expected latency, which can be transmitted via a message from T-BS to S-BS. Such exemplary determined value for the expected latency may be used by the T-BS 308 to pre-compensate the action time for a particular MS, when the T-BS 308 sends the action time value to the S-BS 302 within a HO_RSP message.

The action time may be a number of slots per time, for example, the nominal action time may have a nominal value of 5 slots. Thus, in an example, a first T-BS may determine a latency of one slot and a second T-BS determines a latency of two slots. Thus, the first T-BS can determine the action time as 5−1 slots=4 slots and the second T-BS may determine 5−2 slots=3 slots. For example, the nominal action time may indicate the time of how long a fast handover may be supported by the corresponding base station related on the time basis of the target base station. Thus, in a time system related to the S-BS, an adaptation may have to be performed to move the time line such, that the action time corresponds to the time line of the S-BS.

As another example, a first T-BS can have an action time, e.g., a nominal action time, AT1=10 and latency T1=2 and the second T-BS has AT2=10 and latency T2=3. For example, the first T-BS and the second T-BS may already have the same value and thus, the T-BSs can be aligned. The T-BS1 can transmit the pre-compensated action time AT1=8, and the T-BS2 can transmit AT2=7. The S-BS may receive AT1=8 and subtract latency 2 again, arriving at the value of 6 and the same S-BS receives AT2=7 and subtract latency 3 again, thus arriving at the value of 4.

AT1 can be received at time T0+2×T1=T0+4 and AT2 may be received at time T0+2×T2=T0+6, whereas T0 is related to the time in the T-BSs. Thus, AT=6 at time 4 points to slot 10 and AT=4 at time 6 points to slot 10 as well. Therefore, the same value can be communicated to the terminal. Alternatively the statistics may also be collected within the S-BS 302. For collecting the latency statistics within the S-BS 302, the T-BS 308 time stamps a HO_RSP signal or a plurality of HO_RSP signals which the T-BS 308 sends to the S-BS 302. The S-BS 302 subtracts the time stamp value from the actual time (TOA) in order to determine a sample of latency.

The S-BS 302 can collect short-term statistics of latencies experienced in previous handover events from S-BS to T-BS related to other MSs within a configurable time window. The S-BS 302 can utilize the short-term statistics to calculate the current expected latency for a message transfer from the T-BS 308 to the S-BS 302. The S-BS may determine the expected latency or an estimation for the latency by generating an average value from the collected statistical information. The calculated latency value or the expected latency value can be passed to the T-BS 308. For passing the estimated latency value from the S-BS 302 to the T-BS 308 a HO_ACK message can be used, which may be transmitted as a response to a HO_RSP message of the current exchange of information which is used for the next handover event. For transporting the expected latency value from the S-BS 302 to the T-BS 308, the next HO_REQ message may also be used of the next HO procedure over the R6/R4 interface to the T-BS 308.

The value for the expected latency can be used by the T-BS 308 to pre-compensate the action time for a particular MS, when the T-BS 308 sends the action time in a HO_RSP message to the S-BS 302. A trigger for a handover can be the MS mobility management or the network. In a network based handover, a trigger for handover can be generated by a resource management. If an MS believes that the MS receives a better service from another BS, the MS can request a handover. Reasons for the change of the BS may be poor performance with the current BS, a better signal and/or the promise of a better performance in another BS.

The S-BS 302 may also wait until the S-BS 302 has received the action time responses from a pre-configured percent value, for example X %, of candidate T-BS 308 in a HO_RSP message. The S-BS 302 can decide on one value of the action time or on one action time, which is to be used. For example, the S-BS 302 can select the largest received value for an action time or uses an own value based on the information received from the terminal, e.g., HO readiness value. The HO readiness value may be optional information which a BS may have received from the MS. This value can indicate how long the corresponding MS need to perform a handover. The S-BS may take this value into account, when the S-BS chooses an appropriate value for an action time from a plurality of different values. A value which is too short may “over-stretches” or overloads the corresponding MS and the S-BS may select a value for the action time, which the terminal can achieve.

When such a value is selected, the S-BS can inform the plurality of T-BS about the selected value. Thus, in advanced, the T-BS may be adapted to provide an adequate value for the action time for the corresponding mobile terminal. The value, which is selected from the S-BS 302 for the action time, can be transmitted or signalled to the MS inside a MOB_BS_RSP message via the radio interface R1. The selected value of action time in parallel can be transmitted to the plurality of T-BS in a HO_ACK message and to the MS. Each of the plurality of T-BS 308 can adopt or refresh the new value as nominal action time value for the MS. This signal for action time can be time stamped and T-BS can correctly decide on the effective timing for fast ranging opportunity.

Thus, the T-BSs may select an action time independently from the S-BS. However, the S-BS can select one value that the S-BS considers as appropriate for an MS and the S-BS communicates the selected action time value to at least one MS and to all T-BSs which are adapted to adjust their scheduling or their nominal action time accordingly to receive the mobile terminal at the time as selected by S-BS.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties. Exemplary and non-limiting acronyms and terminology described herein are provided as follows:

### BS Base Station

### CDMA Code Division Multiple Access

### HO Hand-over

### MS Mobile Station

### S-BS Serving Base Station

### TBD To Be Done

### T-BS Target Base Station

### TOA Time of Arrival

WiMAX Worldwide Interoperability for Microwave Access

What is claimed is:

1. A method for determining an action time in a communication network, comprising:
in a target network arrangement, estimating a first value for an action time which corresponds to a second value for a handover time interval related to the target network arrangement, wherein the handover time interval is a time interval starting provided substantially at the time when a first signal is received by a serving network arrangement, the first signal comprising information relating to the first value, and wherein the handover time interval has a duration during which the target network arrangement is prepared to receive a handing or a control over at least one user equipment;
transmitting the first signal from the target network arrangement to the serving network arrangement;
receiving the first signal in the serving network arrangement; and
transmitting a second signal to the at least one user equipment, the second signal comprising the information regarding the first value for the action time.

2. The method of claim 1, further comprising:
in a further target network arrangement, estimating a third value for a further action time which corresponds to a fourth value for a further handover time interval;
transmitting, from the further target network arrangement to the serving network arrangement, a third signal comprising information regarding the third value;
receiving the third signal in the serving network arrangement;
selecting at least one value of the first value for the action time and the second value for the further action time;
transmitting the second signal comprising information regarding the at least one selected value for the action time to the at least one user equipment and to the target network arrangement.

3. The method of claim 1, wherein the estimation of the first value in the target network comprises in the target network arrangement, determining a further value for a delay of at least one message transmitted from the serving network arrangement to the target network arrangement.

4. The method of claim 1, wherein the estimation of the first value in the target network comprises:
in the serving network arrangement, determining at least one further value for a delay of at least one message transmitted from the target network arrangement to the serving network arrangement; and
transmitting, to the target network arrangement, the at least one further value for the delay.

5. The method of claim 4, further comprising, in the target network arrangement, determining a statistic value for a plurality of values for the delay.

6. The method of claim 4, further comprising, in the serving network arrangement, determining a statistic value for a plurality of values for the delay.

7. The method of claim 1, wherein the estimation of the first value in the target network arrangement comprises subtracting a value for a delay for transmitting a message from a nominal value of the action time.

8. The method of claim 1, wherein the estimation of the first value in the target network arrangement comprises determining a value for transmitting at least one message selected from a group of messages, the group including a HO_RSP message, a HO_Ack message and a HO_Req message.

9. A method for distributing an action time value, comprising:
receiving a plurality of action time values in a serving network arrangement;
selecting at least one value of the plurality of action time values;
distributing the at least one selected action time value to at least one user equipment; and
distributing the at least one selected action time value to a target network arrangement.

10. The method of claim 9, wherein the at least one selected action time value is distributed to the at least one user equipment and the target network arrangement in parallel.

11. A target network arrangement, comprising:
an estimating device configured to estimate a first value for an action time which corresponds to a second value for a handover time interval of a target network arrangement, wherein the handover time interval is a time interval starting substantially at a time when a first signal is received by a source network arrangement, the first signal including information about the first value, and wherein the handover time interval has a duration during which the target network arrangement is prepared for a handover of at least one user equipment, and
a transmitting device configured to transmit the first signal from the target network arrangement to a serving network arrangement.

12. A serving network arrangement, comprising:
a receiving device configured to receive at least one first signal comprising information regarding a value for an action time in a target network arrangement;
a selecting device configured to select one of the at least one signal; and
a transmitting device configured to transmit the selected at least one signal to a user equipment.

13. A communication system, comprising:
at least one target network arrangement including:
an estimating device configured to estimate a first value for an action time which corresponds to a second value for a handover time interval of a target network arrangement, wherein the handover time interval is a time interval starting substantially at a time when a first signal is received by a source network arrangement, the first signal including information about the first value, and wherein the handover time interval has a duration during which the target network arrangement is prepared for a handover of at least one user equipment; and
at least one serving network arrangement including:
a receiving device configured to receive the first signal comprising information regarding a value for the action time in a target network arrangement;
a selecting device configured to select one of the first one signal; and
a transmitting device configured to transmit the selected first signal to the at least one user equipment;
wherein the at least one target network arrangement including a transmitting device which is configured to transmit the first signal from the target network arrangement to the at least one serving network arrangement, and
wherein the at least one serving network arrangement is configured to handover the at least one user equipment to the at least one target network arrangement.

14. The communication system of claim 13, wherein at least one of the target network arrangement or the serving network arrangement is a WiMAX network node.

15. Computer-accessible medium which includes instructions thereon for determining an action time in a communication network, wherein, when a processing arrangement executes the instructions, the processing arrangement is configured to:
cause and estimation of a first value for an action time in a target network arrangement, the first value corresponding to a second value for a handover time interval related to the target network arrangement, wherein the handover time interval is a time interval starting provided substantially at the time when a first signal is received by a serving network arrangement, the first signal comprising information relating to the first value, and wherein the handover time interval has a duration during which the target network arrangement is prepared to receive a handing or a control over at least one user equipment;
cause a transmission of the first signal from the target network arrangement to the serving network arrangement;
cause a receipt of the first signal in the serving network arrangement; and
cause a transmission of a second signal to the at least one user equipment, the second signal comprising the information regarding the first value for the action time.
